(19) United States
(12) Patent Application Publication
(10) Pub. No.: US 2022/0105853 A1
(43) Pub. Date: Apr. 7, 2022

(54) Delivery Package Loading Structure and Method in Cargo Container

(71) Applicants: Hyundai Motor Company, Seoul (KR); Kia Corporation, Seoul (KR)

(72) Inventors: Jae Seung Lee, Hwaseong-si (KR); Seung Sik Han, Hwaseong-si (KR); Dae Hee Lee, Incheon (KR); Yong Hyun Nam, Anyang-si (KR)

(21) Appl. No.: 17/363,674

(22) Filed: Jun. 30, 2021

(30) Foreign Application Priority Data
Oct. 6, 2020 (KR) 10-2020-0128454

(51) Int. Cl. B60P 1/32; B60P 1/00; B60P 1/28; B60P 1/52; G08G 1/0968

(52) U.S. Cl. CPC B60P 1/32; B60P 1/006; G08G 1/096833; B60P 1/52; B60P 1/28

(57) ABSTRACT

A delivery package loading structure in a cargo container includes a carrier tray configured to move package along a longitudinal direction of the cargo container, a mounting section located on both lateral sides of the carrier tray and configured to hold the package thereon in a height direction of the cargo container, and a control unit configured to, based on destination information or delivery order of the package, set a longitudinal movement of the package by the carrier tray, drive the carrier tray to transfer the package to the mounting section, and determine a height position of the package to be loaded into the mounting section.

### CROSS-REFERENCE TO RELATED APPLICATIONS

This application claims the benefit of Korean Patent Application No. 10-2020-0128454, filed on Oct. 6, 2020, which application is hereby incorporated herein by reference.

### TECHNICAL FIELD

The present disclosure relates to a delivery package loading structure and method in a cargo container.

### BACKGROUND

In a package delivery system, the parcel company distributes packages to respective parcel drivers belonging thereto, and the respective parcel drivers check the daily delivery volume and delivery addresses of the distributed packages, arrive at the respective delivery addresses, deliver the packages, and complete the delivery.

To this end, the parcel driver arrives at the customer's address and delivers the parcel package through the process of identifying the approximate location of the destination on the basis of the geographic information through his/her experience, and checking the address of the destination through a navigation system or map, and delivers the package and completes the delivery.

At this time, even if the parcel driver in charge of the delivery knows roughly the geographic information of the destination area, it is difficult to identify the shortest travel route in the entire travel route by repeatedly checking the navigation system and map. Thus, depending on his/her selection, problems such as initially moving to a distant destination instead of a nearby destination and then moving to the nearby destination in the course of delivery may occur. Due to this, the moving distance and time may increase, as well as delivery delay may occur.

In addition, in the case of a parcel driver who is out of his/her destination area or does not understand the geographic information of the destination area, there is a problem that the delivery is carried out without taking into account the travel distance or the route during delivery. This may cause a problem of the parcel driver not being able to accomplish his/her daily delivery assignment, and may cause customers inconvenience in not receiving the package at their desired time due to delayed delivery.

In the related art, a method of setting a route for a plurality of stops is disclosed, in which method the optimal route is set on the basis of the route travel time between the stops and the route travel time between the departure point and the stops, so that in the case where the package delivery is required to go through multiple stops regardless of priority from the departure point to the destination, a courier can go through respective stops through the optimal route without continuing to enter the destination or set any special settings in the minimum time.

However, in the related art, physical time for sorting packages loaded in the cargo container and selectively unloading the packages suitable for the destinations is required, thus resulting in time and economic losses.

Korean Patent Application Publication No. 10-2013-0111801 describes information related to the present subject matter.

### SUMMARY

The present disclosure relates to a delivery package loading structure and method in a cargo container. Particular embodiments relate to a delivery package loading structure and method in a cargo container to efficiently load delivery packages inside a cargo container on the basis of address information of delivery packages.

Accordingly, embodiments of the present disclosure can solve problems occurring in the related art, and an embodiment of the present disclosure provides a delivery package loading structure for a cargo container, configured to locate packages according to a delivery order on the basis of address information of the packages.

In addition, another embodiment of the present disclosure provides a delivery package loading structure for a cargo container, the loading structure being capable of automatically setting a driving route on a navigation system in response to destination address information of packages.

The embodiment of the present disclosure are not limited to those mentioned above, and other features of embodiments of the present disclosure that are not mentioned can be more clearly understood by embodiments in the following description. In addition, the embodiments of the present disclosure can be realized by configurations defined by claims and combinations thereof.

According to one embodiment of the present disclosure, there is provided a delivery package loading structure in a cargo container, the structure including a carrier tray configured to move a package along the longitudinal direction of the cargo container, a mounting section located on both lateral sides of the carrier tray to load at least one package thereon in the height direction of the cargo container, and a control unit configured to, on the basis of destination information of a package, set the longitudinal movement of the package by the carrier tray, drive the carrier tray to transfer the longitudinally-moved package to the mounting section, and determine the height position of the package to be loaded into one mounting section according to the delivery order of the packages.

In addition, the carrier tray may further include at least one plate disposed in the longitudinal direction of the cargo container, a roller unit partially protruding from an upper surface of the plate to move the package in the longitudinal direction, a driving unit applying a driving force to the roller unit, and a transfer section positioned on the plate to transfer the package loaded on the plate to the mounting section.

In addition, the transfer section may further include a loading roller part positioned on the plate in a direction transverse to the roller unit.

In addition, the transfer section may further include a tilting driving part configured to selectively lift both lateral end sides of the plate.

In addition, the mounting section may include a plurality of mounting plates respectively moved in a vertical direction, a mounting guide guiding the vertical movement of the mounting plates, and a mounting driving unit positioned around the mounting plate to provide a driving force to move the mounting plate in the vertical direction.

In addition, the mounting driving unit may be engaged with a gear part formed on the mounting guide to move the mounting plate in a height direction.

In addition, the package loading structure may further include a pusher section disposed in the cargo container to move in a width direction of the cargo container along an upper surface of the mounting plate.

In addition, the control unit may be configured to load a package having a relatively far destination on a relatively high mounting plate of the mounting section.

In addition, the control unit may be configured to move a package having a relatively far destination to the mounting section that is on the relatively-front side of the cargo container, among the mounting sections arranged in the longitudinal direction.

In addition, the control unit may be configured to set a driving route of a vehicle on the basis of address information of the packages to be loaded, and as a package has a relatively far destination on the set driving route, to move the package toward a relatively high position of the mounting section on the relatively-front side of the cargo container.

In addition, the control unit may be configured to set a driving route of a vehicle on a navigation system on the basis of address information of the packages.

In addition, the control unit may be configured to move a target package to be unloaded toward the rear side of the cargo container along the carrier plate on the basis of address information of packages corresponding to the location of a vehicle.

According to another embodiment of the present disclosure, there is provided a delivery package loading method performed in a cargo container by a control unit, the method including receiving address information of packages, moving a package having a relatively far destination toward the front side of a cargo container using a carrier tray on the basis of the address information, loading a package moved along the carrier tray on a mounting section, and unloading a target package having address information corresponding to the destination toward the rear side of the cargo container along the carrier tray.

In addition, the step of receiving the address information of the packages may include transmitting the address information input to a tag to a vehicle and setting a driving route of the vehicle on a navigation system on the basis of the transmitted address information.

In addition, the step of loading the package moved along the carrier tray on the mounting section may further include loading a package having a relatively long delivery distance on the mounting section at a relatively high position according to a delivery distance of a package transferred to the mounting section.

In addition, the step of unloading the package having the address information corresponding to the destination may further include lowering the mounting section and deploying a pusher section to transfer the package to the carrier tray.

Embodiments of the present disclosure can obtain the following effects by the configurations and combinations thereof of exemplary embodiments that will be described below.

Embodiments of the present disclosure can have an effect of providing an efficient driving environment through the delivery package loading structure method for a cargo container that can automatically set a driving route in response to input of address information of packages.

In addition, embodiments of the present disclosure can have the effect of performing a more efficient business when loading and unloading packages through the package loading structure capable of performing automatic loading and unloading of packages.

### BRIEF DESCRIPTION OF THE DRAWINGS

FIG. 1 is a perspective view illustrating a delivery package loading structure for a cargo container according to an embodiment of the present disclosure;

FIG. 2 is a perspective view illustrating a carrier tray of the delivery package loading structure according to an embodiment of the present disclosure;

FIG. 3 is a driving diagram illustrating the carrier tray according to an embodiment of the present disclosure;

FIG. 4 is a side cross-sectional view illustrating the carrier tray that is driven according to an embodiment of the present disclosure;

FIG. 5A is a driving diagram illustrating a mounting section of the delivery package loading structure according to an embodiment of the present disclosure;

FIG. 5B is an enlarged view illustrating the mounting section of the delivery package loading structure according to an embodiment of the present disclosure;

FIG. 6A is a driving diagram illustrating a pusher section of the delivery package loading structure according to an embodiment of the present disclosure;

FIG. 6B is an enlarged view illustrating the pusher section of the delivery package loading structure according to an embodiment of the present disclosure; and

FIG. 7 is a flow chart illustrating a delivery package loading method in a cargo container according to an embodiment of the present disclosure.

### DETAILED DESCRIPTION OF ILLUSTRATIVE EMBODIMENTS

Hereinafter, embodiments of the present disclosure will be described in more detail with reference to the accompanying drawings. The embodiments of the present disclosure may be modified in various forms, and the scope of the present disclosure should not be construed as being limited to the following embodiments. The present embodiments are provided to more completely explain the present disclosure to ordinary skilled persons in the art.

In addition, terms such as “ . . . unit”, “ . . . tray”, “ . . . gear”, or the like described herein means a unit that processes at least one function or operation, which is implemented as hardware, software, or a combination thereof.

In addition, in the present specification, the names of the configurations are classified into first, second, etc. to distinguish them because the names of the configurations are the same, and are not necessarily limited to the order in the following description.

Hereinafter, exemplary embodiments will be described in detail with reference to the accompanying drawings, and in the following description, the same or corresponding constituent elements are assigned the same reference numerals, and redundant descriptions thereof will be omitted.

The present disclosure relates to a delivery package loading structure and method in a cargo container, which will be sequentially described below.

In the present disclosure, the cargo container means all container constructions that are mounted on the rear side of a vehicle to allow packages to be loaded/unloaded on/from the cargo container.

In addition, the longitudinal direction used herein refers to the longitudinal direction of a vehicle or a cargo container, and the height direction refers to the vertical direction based on the bottom of the vehicle or cargo container. Further, the front side of the cargo container means the end side coupled to a motorized vehicle, while the rear side of the cargo container means the end side that is opposite to the front side and where an end gate exists so that packages are loaded or unloaded therethrough.

The control unit disclosed herein can be interpreted in a broad concept including a control unit of a vehicle, and can receive information on baggage from a logistics tag attached to a package, and control the driving of various components located in the vehicle. In addition, the control unit may include a controller capable of interlocking with the navigation system located in the vehicle.

In the present disclosure, packages are classified on the basis of a ‘destination address’, ‘delivery information’, and a ‘delivery order’, and the ‘destination address’, ‘delivery information’ and ‘delivery order’ mean destination information according to the order of destination based on the travel route on a navigation system, and does not include a simple concept of distance. In addition, as used herein, the ‘order of destination’ and ‘delivery distance’ refer to a relationship in which the order of procedure is determined in a time series during driving of a vehicle.

In embodiments of the present disclosure, packages may be tagged in a distribution center to classify target loading cargo containers, and additionally, the packages may be tagged immediately before being loaded into the cargo container to set the loading location of the packages in the cargo container. Alternatively, the packages may be tagged in a distribution center such that target loading cargo containers are automatically set and at the same time, the loading location of the packages in the cargo container is set.

The tag includes delivery information, area information, and destination address information of the package, and can be composed of barcodes or the like. As the tag is tagged, the control unit sends the information to the server using wired or wireless communication to update the location, delivery schedule, or the like of the package.

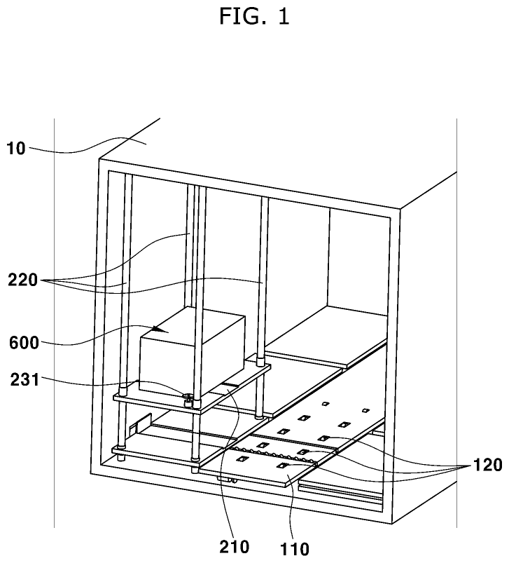

FIG. 1 is a perspective view illustrating a delivery package loading structure in a cargo container according to an embodiment of the present disclosure.

The delivery package loading structure is provided in a space of a cargo container 10 in which packages 600 can be loaded through an end gate of the cargo container, and includes a carrier tray 100 extending in the longitudinal direction at the bottom of the cargo container 10. The carrier tray 100 is configured to be positioned at least in part in the width direction of the cargo container 10, and may be connected to the front end of the cargo container 10 in the longitudinal direction.

On both sides of the carrier tray 100, mounting sections 200 are provided, and the mounting sections 200 may be located adjacent to one another along the longitudinal direction of the cargo container 10, wherein each of the mounting sections is provided with a plurality of rack layers, which may be positioned at a different height in the vertical direction by the operation of the control unit 500. More preferably, the mounting section 200 includes a plurality of mounting plates 210, which are positioned sequentially from a position closest to the bottom of a vehicle or cargo container.

In an embodiment of the present disclosure, three mounting plates 210 are provided, wherein the first mounting plate 210, which forms the top rack layer, is configured to place the package 600 having a target destination at the farthest (last) delivery location on the navigation system 400, and the third mounting plate 210 is configured to place the package 600 having a target destination at the closest (fastest) delivery location. The package 600 loaded on the second mounting plate 210 has a target destination at the middle delivery location between the farthest delivery location of the package 600 on the first mounting plate 210 and the closest delivery location of the package 600 on the third mounting plate 210.

In this way, the mounting plates 210 of the mounting sections 200 are configured to be moved in the height direction on the basis of the destination information of the packages 600 moved along the carrier tray 100. Moreover, the control unit 500 controls the loading positions of the packages on the mounting section such that the package 600 loaded on the topmost mounting plate 210 of the mounting section has the farther target destination than those of the packages 600 loaded on the other mounting plates 210 of the mounting section 200.

That is, the stacked mounting plates 210 are located in the order of destinations of the packages 600 such that the package 600 having the farthest destination is loaded on the topmost mounting plate 210, and the package 600 having the closest destination is loaded on the lowest mounting plate 210.

The control unit 500 is configured to receive information about the packages 600 that are moved to the carrier tray 100. In addition, the control unit is configured to determine the position of the initially loaded package 600 on the basis of the transport area of the package 600. In other words, the control unit is configured to receive the destination information of the initially loaded package 600 on the basis of the transport area, and in the case where the destination is relatively far along the traveling route of the transport area, move the package 600 toward the relatively-front side of the cargo container 10. Thereafter, the control unit 500 is configured to compare destination information between the previously loaded package 600 and a new package 600 being loaded into the cargo container 10, and determine positions of the mounting section and the mounting plate 210 thereof on which the new package 600 is to be loaded.

More preferably, the control unit 500 can receive information about all the packages 600 expected to be initially loaded, and set the loading positions of the corresponding packages 600. Thus, the control unit may be configured to determine the order of the mounting sections 200 on which the incoming packages are to be loaded, and the position of the mounting plates of the corresponding mounting section.

The carrier tray 100 includes a plurality of plates 110 that is provided adjacent to each other in the longitudinal direction so that the package 600 is placed thereon and a roller unit 120 configured to at least partially protrude from the upper surface of the plate 110 so as to be in contact with the package 600 and configured to roll in the longitudinal direction of a vehicle. The roller unit 120 is configured to receive the rotational force through a driving unit 140 located at the bottom of the plate 110. In one embodiment of the present disclosure, the roller unit 120 is configured to roll in the same direction by engaging a caterpillar device or a belt with a central shaft 130 of the roller unit 120. Moreover, the roller unit 120 may be configured to be fixed and positioned on the bottom surface of the cargo container 10.

The plate 110 may further include a transfer section configured to transfer a package 600 in a transverse direction with respect to the roller unit 120 to one of the mounting sections located on both lateral sides of the carrier tray 100. The transfer section may include a loading roller part 151 formed on a body plate thereof to roll in the transverse direction, and a tilting driving part 152 positioned to lift one of lateral end sides of the plate 110 on which a package 600 is loaded.

Two tilting driving parts 152 are respectively disposed at the bottom of both lateral sides of the plate 110. The control unit 500 drives the tilting driving part 152 such that one lateral end side of the plate 110 far from a selected mounting section 200 is lifted so that the package 600 loaded on the plate 110 is transferred to the selected one of the mounting sections 200 located on both lateral sides of the carrier tray 100. Accordingly, the plate 110 is laterally tilted so that the package 600 is transferred to the selected mounting section 200 along the roller part 151. More preferably, the plate 110 may be composed of two or more plates, and the tilting driving parts 152 are positioned on each plate 110 such that the tilting driving parts 152 on each plate are driven independently by the control unit 500.

In addition, according to embodiments of the present disclosure, either the roller part 151 or the tilting driving parts 152, or both the roller part 151 and the tilting driving parts 152 may be positioned on each of the plates 110.

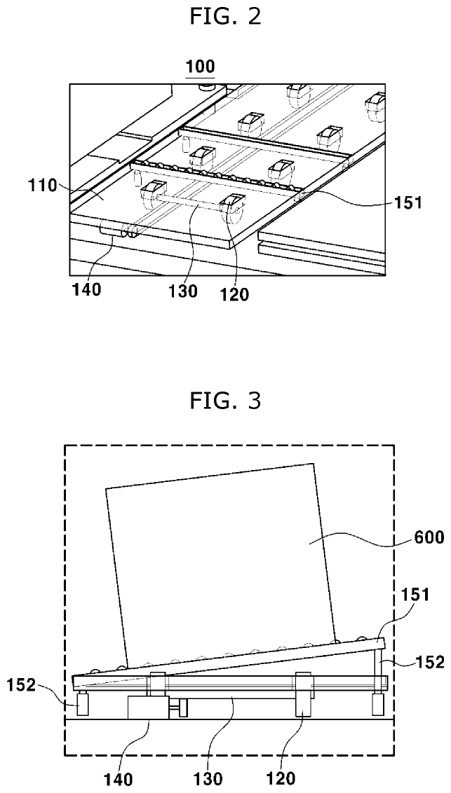

FIGS. 2 and 3 are configuration diagrams of a carrier tray 100 according to an embodiment of the present disclosure.

In the illustrated embodiment, the carrier tray 100 is configured to include a plurality of plates 110 and two rows of roller units 120 on one plate 110. The plate 110 is located around the center in the width direction of the cargo container 10, and the mounting sections 200 are located adjacent to one another on both lateral sides of the plate 110.

A driving unit 140 may be fixedly positioned below the plate 110, and may include a belt or a caterpillar device coupled to the central shaft 130 of the roller unit 120 so that rotational force from the driving unit is transferred to the roller unit 120.

The loading roller part 151 is disposed on the plate 110 in a direction transverse to the roller unit 120. More preferably, the loading roller part 151 is positioned to extend toward both lateral end sides to face the mounting sections 200.

The tilting driving part 152 is provided below both lateral end sides of the plate 110 to lift a selected one of both lateral end sides of the plate 110. The tilting driving part 152 is configured to lift the selected one of the lateral end sides of the plate 110 so that a package 600 loaded on the top of the plate 110 is transferred toward the other lateral end side along the loading roller part 151. More preferably, the tilting driving part 152 may be configured to laterally lift the plate 110 where the loading roller part 151 is located.

The tilting driving parts 152 and the loading roller part 151 are configured to transfer the package 600 that is moved along the carrier tray 100 to the selected mounting section 200, wherein the rotation of the roller unit 120 and the driving point of the tilting driving part 152 may be controlled by the control unit 500.

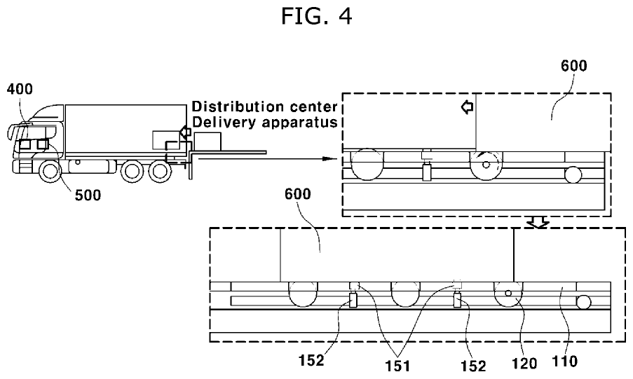

FIG. 4 illustrates the structure in which the package 600 is transferred into the cargo container 10 through the carrier tray 100.

The carrier tray 100 includes the roller unit 120 configured to partially protrude upward from the plate 110, so that the package 600 is moved along the upper surface of the roller unit 120 in the longitudinal direction of the carrier tray 100. More preferably, when the package 600 is loaded, the control unit 500 drives the driving unit 140 to roll the roller unit 120 toward the front side of the cargo container, and when the package 600 is unloaded, the control unit controls the roller unit 120 to roll in a direction toward the rear side of the cargo container.

Moreover, the carrier tray 100 is configured to be fastened to a treadmill as a delivery device of a distribution center so that the package 600 may be continuously moved into the cargo container 10 from the distribution center. The packages 600 are moved along the carrier tray 100 and then transferred to the mounting sections 200 according to the transport information of the package, wherein the transfer movement is carried out by the operation of the tilting driving part 152.

Below the plate no, the central shaft 130 of the roller unit 120 and a belt connected along the central shaft 130 are disposed, wherein the belt is circulated by the driving force of the driving unit 140 so that the roller unit 120 rolls in one direction. More preferably, the central shaft 130 of the roller unit 120 is fixed to the bottom of the cargo container 10 to roll independently of the driving of the plate 110. Even when the plate 110 is tilted by the tilting driving part 152, the central shaft 130 may be driven in a fixed state to the vehicle body.

The control unit 500 is configured to control the amount of rotation of the driving unit 140 of the carrier tray 100 in order to control the longitudinal position of the package 600 on the basis of the destination information of the package 600. Therefore, as the destination distance is far, the package 600 is moved toward and placed on the relatively-front side of the cargo container. More preferably, it is configured that a package 600 having relatively far (late) destination based on the traveling route input to the navigation system 400 is moved toward the relatively-front side of the cargo container 10.

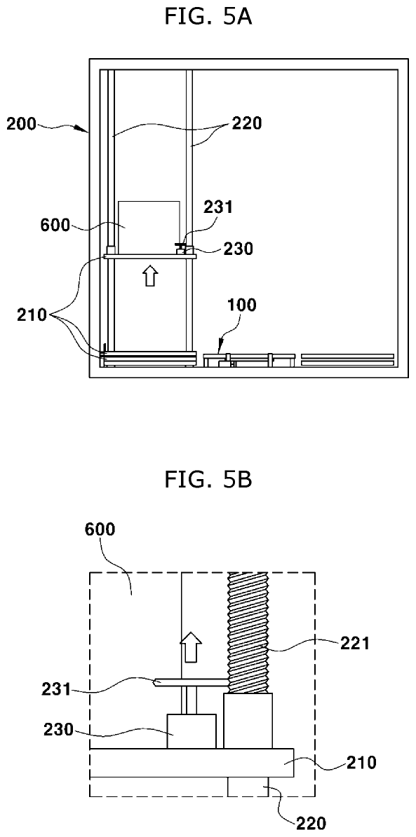

FIG. 5A is a front view illustrating the cargo container 10 including the mounting section 200.

At least one mounting section 200 is disposed on both lateral sides of the carrier tray 100, and at least one mounting section is disposed in the longitudinal direction. The mounting section 200 includes one or more mounting plates 210 that can be moved along the height direction of a vehicle.

Initially, the mounting plates 210 are positioned adjacent to the bottom of the cargo container 10 in a state of being overlapped with each other. Furthermore, the top surface of the mounting plate 210 disposed adjacent to the bottom of the cargo container 10 in a stacked state may be positioned to be parallel or lower in height, compared to the top surface of the plate 110 of the carrier tray 100.

The plurality of mounting plates 210 are configured to be moved along a mounting guide 220 positioned in the height direction of a vehicle, and a mounting driving unit 230 positioned on each mounting plate 210 is coupled to the mounting guide 220 to provide a driving force for the mounting plate 210 to move in the vertical direction.

More preferably, according to an embodiment of the present disclosure, the mounting driving unit 230 is composed of a motor and includes a toothed structure 231 fastened to a central shaft of the motor, wherein the toothed structure 231 is engaged with a gear part 221 formed along the outer surface of the mounting guide 220 to perform the vertical movement of the mounting plate 210.

FIG. 5B illustrates a fastening relationship between the mounting guide 220 and the mounting driving unit 230 protruding from the upper surface of the mounting plate 210, wherein the mounting driving unit 230 includes the toothed structure 231 that is coupled to the central rotary shaft. The toothed structure 231 is configured to be engaged with the gear part 221 formed along the outer surface of the mounting guide 220. The gear part 221 is configured to have a helical structure, and allows the toothed structure 231 to move vertically along the mounting guide 220 according to the rotation of the mounting driving unit 230, thereby performing the vertical movement of the mounting plate 210 integrally formed with the mounting driving unit 230.

The control unit 500 controls the package 600 moved along the carrier tray 100 to be transferred to and loaded on the mounting section 200, and when the package 600 is loaded on the mounting plate 210 of the mounting section 200, the height of the mounting plate 210 is controlled according to the destination information. More preferably, in the case where a plurality of packages 600 is loaded into a single mounting section 200, the package 600 having a relatively late (far) destination may be positioned on the mounting plate 210 at a relatively high position, whereas the package 600 having a relatively fast (close) destination may be positioned on the mounting plate 210 at a relatively low position.

Therefore, the control unit 500 is configured to receive destination information of a plurality of packages 600 loaded into one mounting section 200 and load the package 600 having a relatively farthest destination on the mounting plate 210 that can be moved to the uppermost position. That is, the package 600 having the relatively farthest destination is loaded on the mounting plate 210, which is in turn moved to the top in the height direction by the driving force of the mounting driving unit 230. Thereafter, other respective mounting plates 210 may be located at a position adjacent to the bottom of the immediately above mounting plate 210 such that the packages 600 are sequentially loaded thereon according to the farther destination.

In an embodiment of the present disclosure, the mounting section 200 including three mounting plates 210 is disclosed, so that the packages 600 are sequentially loaded on the mounting plates from bottom to top in a height direction according to the destination distance.

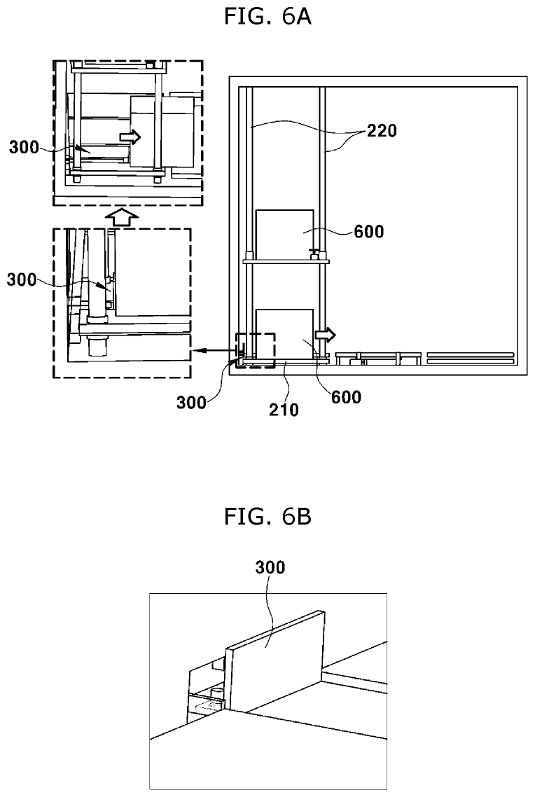

FIG. 6A illustrates that when arriving at the destination, a package 600 is unloaded from the mounting plate 210 and transferred to the carrier tray 100, and FIG. 6B illustrates the configuration of a pusher section 300.

The pusher section 300 is disposed on a lateral side of the cargo container 10 adjacent to the mounting sections 200 so as to perform a pushing operation near the upper surface of the mounting plate 210, in the transverse direction of a vehicle. The pusher section 300 is located at a position that is adjacent to the lateral side of the cargo container 10 and does not interfere with the vertical movement of the mounting plate 210. The control unit 500 controls the package 600 loaded on the mounting plate 210 to be transferred to the carrier tray 100 and unloaded from the cargo container 10 through the carrier tray 100. In this process, the control unit 500 is configured to control the mounting plate 210 to be moved to a position adjacent to the bottom of the cargo container 10 and then drive the pusher section 300 to apply a predetermined force to the lateral side of the package 600.

In an embodiment of the present disclosure, the pusher section 300 may be configured to be movable in the longitudinal direction of a vehicle so that the pusher section 300 may be movable to positions corresponding to the mounting sections 200 arranged in the longitudinal direction. In another embodiment, a plurality of pusher sections 300 may be provided in the cargo container 10 at which the mounting sections 200 are located.

The mounting plate 210 has a groove that corresponds to a traveling path of the pusher section 300, which is configured to be deployed along the groove of the mounting plate 210 in the width direction of a vehicle.

In addition, the pusher section 300 may include a rod fastened to a vehicle body, a motor configured to deploy the rod in the width direction of a vehicle, and a pushing plate configured to contact a package 600.

The control unit 500 is configured to receive destination information of a target package to be unloaded by the navigation system 400 and move the target package 600 to the carrier tray 100 on the basis of the received information. Therefore, the control unit 500 controls the mounting plate 210 having the target package 600 to be lowered to a position adjacent to the bottom of the cargo container 10, and drive the pusher section 300 in the width direction of the lowered mounting plate 210.

In addition, the control unit 500 is configured to drive the mounting driving unit 230 to stop the mounting plate 210 at a higher position than the plate 110 of the carrier tray 100 to allow the package 600 to be moved to the carrier tray 100 by the pusher section 300.

Accordingly, the package 600 is transferred from the mounting plate 210 to the carrier tray 100, and then is moved toward the rear side or the end gate of the cargo container 10 as the roller unit 120 of the carrier tray 100 rolls.

As described above, according to the package 600 loading structure in a cargo container 10, the positions of the packages to be loaded into the cargo container 10 are set on the basis of the delivery information received through the control unit 500, and when arriving at the destination, the packages are moved to unloading positions in association with the navigation system 400.

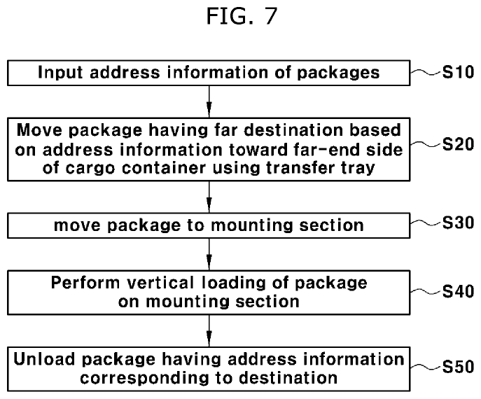

FIG. 7 is a flowchart illustrating a delivery package 600 loading method in a cargo container 10 according to another embodiment of the present disclosure.

The packages 600 are tagged before being loaded into the distribution center or the cargo container 10, and the control unit 500 is configured to receive the destination information of the packages 600 through tagging (S10). After receiving the destination information, the control unit 500 is configured to transmit the destination information to a vehicle and set a traveling route on the basis of the addresses transmitted from the navigation system 400 (S10).

When the package 600 is loaded inside the cargo container 10, the control unit 500 drives the carrier tray 100 such that the package 600 with a relatively far destination is moved toward a relatively-front side of the cargo container on the basis of the destination information of the package 600 (S20).

In addition, the package 600 moved in the longitudinal direction of a vehicle through the carrier tray 100 is subsequently transferred to the mounting section 200. When a plurality of packages 600 is moved to a single mounting section 200, the control unit 500 moves the plurality of mounting plates 210 in the height direction so that the packages 600 are loaded on the mounting plates 210, respectively (S30). Moreover, when the plurality of packages 600 is loaded into one mounting section 200, the control unit 500 is configured to determine the loading order such that an initially loaded package 600 has the farthest destination address. Therefore, the initially loaded package 600 introduced into the mounting section 200 is controlled such that the package has a relatively far or late destination compared to the subsequently loaded package 600, and is loaded on the top of the corresponding mounting section 200 with the upward movement of the mounting plate 210 (S40).

Thereafter, when it is determined that a vehicle has arrived at the destination, the package 600 located in the mounting section 200 is lowered and then transferred from the mounting plate 210 to the carrier tray 100 by the pusher section 300. The roller unit 120 of the carrier tray 100 rolls so that the package 600 is moved toward the rear side of the cargo container (S50).

The above detailed description is illustrative of embodiments of the present disclosure. In addition, the above description shows and describes preferred embodiments of the present disclosure, and the present disclosure can be applied in various other combinations, modifications and environments. That is, changes or modifications may be made within the scope of the concept of the invention disclosed in the present specification, the equivalent scope of the disclosed content, and/or the skill or knowledge in the art. The described embodiments describe the best mode for implementing the technical idea of the present disclosure, and various changes required in the specific application fields and uses of the present disclosure are possible. Therefore, the detailed description of the invention is not intended to limit the invention to the disclosed embodiments. In addition, the appended claims should be construed as including other embodiments.

What is claimed is:

1. A delivery package loading structure in a cargo container, the structure comprising:
a carrier tray configured to move a package along a longitudinal direction of the cargo container;
a mounting section located on both lateral sides of the carrier tray and configured to hold the package thereon in a height direction of the cargo container; and
a control unit configured to, based on destination information or delivery order of the package, set a longitudinal movement of the package by the carrier tray, drive the carrier tray to transfer the package to the mounting section, and determine a height position of the package to be loaded into the mounting section.

2. The structure of claim 1, wherein the carrier tray farther includes:
a plate disposed in the longitudinal direction of the cargo container;
a roller unit partially protruding from an upper surface of the plate and configured to move the package in the longitudinal direction;
a driving unit configured to apply a driving force to the roller unit; and
a transfer section positioned on the plate and configured to transfer the package loaded on the plate to the mounting section.

3. The structure of claim 2, wherein the transfer section further includes a roller part positioned on the plate in a direction transverse to the roller unit.

4. The structure of claim 2, wherein the transfer section further includes a tilting driving part configured to selectively lift both lateral end sides of the plate.

5. The structure of claim 1, wherein the control unit is configured to set a driving route for the cargo container based on address information of the package.

6. The structure of claim 5, wherein the package has a relatively far destination on the driving route, and wherein the control unit is configured to move the package toward a relatively high position of the mounting section toward a front end of the cargo container.

7. The structure of claim 1, wherein the control unit is configured to set a driving route for the cargo container on a navigation system based on address information of the package.

8. The structure of claim 1, wherein the control unit is configured to move the package toward a rear end of the cargo container along the carrier tray to unload the package based on address information of the package corresponding to a location of the cargo container.

9. A delivery package loading structure in a cargo container, the structure comprising:
a carrier tray configured to move a package along a longitudinal direction of the cargo container;
a mounting section located on both lateral sides of the carrier tray configured to hold the package thereon in a height direction of the cargo container, wherein the mounting section comprises:
a plurality of mounting plates configured to be respectively moved in a vertical direction;
a mounting guide configured to guide a vertical movement of the mounting plates; and
a mounting driving unit positioned around one of the plurality of mounting plates and configured to provide a driving force to move the one of the plurality of mounting plates in the vertical direction; and
a control unit configured to, based on destination information or delivery order of the package, set a longitudinal movement of the package by the carrier tray, drive the carrier tray to transfer the package to the mounting section, and determine a height position of the package to be loaded into the mounting section.

10. The structure of claim 9, wherein the mounting driving unit is configured to be engaged with a gear part formed on the mounting guide to move the one of the plurality of mounting plates in the height direction.

11. The structure of claim 9, further comprising a pusher section disposed in the cargo container and configured to move in a width direction of the cargo container along an upper surface of the one of the plurality of mounting plates.

12. The structure of claim 9, wherein:
the package comprises a plurality of packages;
one of the plurality of packages has a relatively far destination; and
the control unit is configured to load the one of the plurality of packages on a relatively high one of the plurality of mounting plates compared to other ones of the plurality of mounting plates configured to load other ones of the plurality of packages each having a relatively less far destination in the mounting section.

13. The structure of claim 9, wherein the package has a relatively far destination, and wherein the control unit is configured to move the package to the mounting section positioned toward a front end of the cargo container.

14. A delivery package loading method performed in a cargo container by a control unit, the method comprising:
receiving address information of a plurality of packages;
moving a package of the plurality of packages having a relatively far destination toward a front end of the cargo container using a carrier tray based on the address information;
loading the package moved along the carrier tray on a mounting section; and
unloading the package having the address information corresponding to the destination toward a rear end of the cargo container along the carrier tray.

15. The method of claim 14, wherein receiving the address information of the plurality of packages comprises:
transmitting the address information input to a tag to a vehicle; and
setting a driving route of the vehicle on a navigation system based on the address information.

16. The method of claim 14, wherein loading the package moved along the carrier tray on the mounting section comprises loading the package having the relatively far destination on the mounting section at a relatively high position according to a delivery distance of the plurality of packages loaded on the mounting section.

17. The method of claim 14, wherein unloading the package having the address information corresponding to the destination comprises:
lowering the mounting section; and
deploying a pusher section to transfer the package to the carrier tray.
